(19) United States
(12) Patent Application Publication
(10) Pub. No.: US 2021/0305562 A1
(43) Pub. Date: Sep. 30, 2021

(54) POSITIVE ELECTRODE COMPOSITE ACTIVE MATERIAL PARTICLE, AND METHOD FOR PRODUCING SAME, POSITIVE ELECTRODE, AND SOLID-STATE BATTERY

(71) Applicant: HONDA MOTOR CO., LTD., Tokyo (JP)

(72) Inventors: Noriaki KAMAYA, Saitama (JP); Hiroto MAEYAMA, Saitama (JP); Toru SUKIGARA, Saitama (JP)

(21) Appl. No.: 17/211,848

(22) Filed: Mar. 25, 2021

(30) Foreign Application Priority Data
Mar. 31, 2020 (JP) 2020-062380

(51) Int. Cl. H01M 4/525; H01M 4/505; H01M 4/36

(52) U.S. Cl. CPC H01M 4/525; H01M 2004/028; H01M 4/366; H01M 4/505

(57) ABSTRACT

To provide a positive electrode composite active material particle capable of reducing resistance even when a battery binding force is small or even when a blending amount of positive electrode active material particles is high, and a method for producing the positive electrode composite active material particle, a positive electrode including the positive electrode composite active material particle, and a solid-state battery including the positive electrode. A positive electrode composite active material particle including positive electrode active material particles each made of a lithium-containing oxide and having a surface at least a part of which is coated with a coating material including a sulfide solid electrolyte, and a method for producing the positive electrode composite active material particle, a positive electrode including the positive electrode composite active material particle, and a solid-state battery including the positive electrode.

This application is based on and claims the benefit of priority from Japanese Patent Application No. 2020-062380, filed on 31 Mar. 2020, the content of which is incorporated herein by reference.

### BACKGROUND OF THE INVENTION

### Field of the Invention

The present invention relates to a positive electrode composite active material particle, and a method for producing of the same, a positive electrode, and a solid-state battery.

### Related Art

Conventionally, a technology of preparing slurry using a positive electrode material including a positive electrode active material particle, a solid electrolyte, a binder, a conductive auxiliary agent, and a solvent, and producing a positive electrode using the slurry has been known. For example, a technology for suppressing an increase in electric resistance in the positive electrode by using a styrene-containing binder as a binder and carbon fiber as a conductive auxiliary agent is proposed (see, for example, Patent Document 1).

Patent Document 1: Japanese Unexamined Patent Application, Publication No. 2010-262764

### SUMMARY OF THE INVENTION

However, when electrode materials are dispersed and mixed in a solvent at one time or in divided times to form slurry and formed into an electrode, it is difficult to control an interface of the materials in the electrode. In particular, when a binder is present in the interface between the positive electrode active material particles and the solid electrolyte, the electronic conductivity and the lithium ion conductivity in the interface are inhibited, resulting in increasing the electrical resistance.

When a binder is present in the interface between the positive electrode active material particles and the solid electrolyte, even if the positive electrode for forming a lithium ion path is consolidated, many air gaps remain in the interface between the positive electrode active material particles and the solid electrolyte. Accordingly, the air gaps increase electrical resistance. In particular, when a battery binding force is small, or a blending amount of positive electrode active material particles is high, the electrical resistance is remarkably increased.

The present invention has been made in view of the above, and an object of the present invention is to provide a positive electrode composite active material particle capable of reducing resistance even when the battery binding force is small or even when the blending amount of the positive electrode active material particles is high, and a method for producing the positive electrode composite active material particle, a positive electrode including the positive electrode composite active material particle, and a solid-state battery including the positive electrode.

(1) In order to achieve the above-mentioned objects, the present invention provides a positive electrode composite active material particle (for example, the below-mentioned positive electrode composite active material particle 10) including a positive electrode active material particle (for example, the below-mentioned positive electrode active material particle 11) made of a lithium-containing oxide and having a surface at least a part of which is coated with a coating material (for example, the below-mentioned coating material 14) including sulfide solid electrolyte (for example, the below-mentioned sulfide solid electrolyte 12).

For reducing resistance, it is most important to suppress formation of an air gap in an interface between a positive electrode active material particle and a solid electrolyte, and to increase a contact area between the positive electrode active material particle and the solid electrolyte. In other words, for reducing resistance, it is effective to control an area of a solid electrolyte that is in contact with the positive electrode active material particle to a certain area or more. In this respect, in the positive electrode composite active material particle as described (1), at least a part of the surface of the positive electrode active material particle made of a lithium-containing oxide is coated with a coating material including a sulfide solid electrolyte. Accordingly, coating of the positive electrode active material particle with the sulfide solid electrolyte can suppress generation of an air gap in the interface between the positive electrode active material particle and the sulfide solid electrolyte, and the resistance can be reduced. In particular, since generation of air gaps in the interface between the positive electrode active material particle and the sulfide solid electrolyte can be suppressed, even when a battery binding force is small or even in a case of a high energy density battery in which a blending amount of the positive electrode active material particles is high, the resistance can be reduced.

(2) In the positive electrode composite active material particle as described in (1), the coating material may further include a conductive auxiliary agent (for example, the below-mentioned conductive auxiliary agent 13).

In the positive electrode composite active material particle as described in (2), at least a part of the surface of the positive electrode active material particle is coated with a coating material including sulfide solid electrolyte and a conductive auxiliary agent. In other words, with the presence of the conductive auxiliary agent in the interface between the positive electrode active material particle and the sulfide solid electrolyte can ensure the electronic conductivity. Accordingly, the resistance can be reduced. In particular, even when the battery binding force is small, or in a case of a high energy density battery in which the rate of the positive electrode active material particles is increased, an electron path and a lithium ion path in the interface between each positive electrode active material particle and the coating material can be sufficiently formed, and accordingly, the increase in resistance can be avoided.

(3) In the positive electrode composite active material particle as described in (1) or (2), a value of D/t may be in a range of 9.0 to 150 where D (nm) is a particle diameter D50 of the positive electrode active material particle and t (nm) is an average thickness of the coating material.

Herein, when the surface of the positive electrode active material particle is coated with the coating material, the particle diameter of the positive electrode active material particle and the thickness of the coating material have a large influence on the electronic conductivity in the interface between the positive electrode active material particle and the coating material. Accordingly, if the particle diameter of the positive electrode active material particle and the thickness of the coating material are not controlled to an appropriate range, the electronic conductivity is deteriorated, and the resistance is increased. In this point, in the positive electrode composite active material particle as described (4), the value of D/t is in a range of 9.0 to 150 where D (nm) is a particle diameter D50 of the positive electrode active material particle and t (nm) is an average thickness of the coating material. Thus, in the interface between the positive electrode active material particle and the coating material, the electron path and the lithium ion path can be sufficiently formed, even when the battery binding force is small or even when the blending amount of the positive electrode active material particles is high, the resistance can be reduced.

(4) In the positive electrode composite active material particle as described in (3), in a cross-sectional image of the positive electrode composite active material particle, a rate of an area of the sulfide solid electrolyte in a region at a distance of t (nm) or less from the surface of the positive electrode active material particle with respect to an entire area of the region may be 40% or more.

In the positive electrode composite active material particle as described in (4), in a cross-sectional image of the positive electrode composite active material particle, a rate of an area of the sulfide solid electrolyte in a region at a distance of t (nm) or less from the surface of the positive electrode active material particle with respect to an entire area of the region is made to be 40% or more. Thus, formation of air gaps in the interface between the positive electrode active material particle and the coating material can be suppressed, and a large contact area between the positive electrode active material particles and the sulfide solid electrolyte can be secured. Accordingly, even when the battery binding force is small or even when the blending amount of the positive electrode active material particles is high, the resistance can be reduced.

(5) In the positive electrode composite active material particle as described in any one of (1) to (4), the positive electrode active material particle may include a lithium composite oxide.

In the positive electrode composite active material particle as described in (5), the positive electrode active material particle is made of a lithium composite oxide. Thus, even when the battery binding force is small or even when the blending amount of the positive electrode active material particles is high, excellent electronic conductivity and lithium ion conductivity can be achieved, and the resistance can be reduced.

(6) In the positive electrode composite active material particle as described in any one of (1) to (5), the positive electrode active material particle may be a composite oxide having a layered rock-salt structure including any element of Ni, Co, and Mn.

In the positive electrode composite active material particle (6), the positive electrode active material particle is formed of a composite oxide having a layered rock-salt structure including any element of Ni, Co, and Mn. Thus, even when the battery binding force is small or even when the blending amount of the positive electrode active material particles is high, more excellent electronic conductivity and lithium ion conductivity can be achieved, and the resistance can be reduced.

(7) A method for producing the positive electrode composite active material particle of any one of (1) to (6) is provided. The method includes a mixing step of dry mixing the positive electrode active material particle and the coating material including the sulfide solid electrolyte with each other to obtain the positive electrode composite active material particle having a surface a part of which is coated with the coating material including the sulfide solid electrolyte.

The method for producing the positive electrode composite active material particle as described in (7) includes a mixing step of dry mixing the positive electrode active material particles and the coating material including sulfide solid electrolyte. By shear stress generated by dry mixing, positive electrode composite active material particles in which at least a part of the surface is coated with a coating material including sulfide solid electrolyte can be produced. In particular, when the coating material including a conductive auxiliary agent in addition to the sulfide solid electrolyte is used, since the surface of the positive electrode active material particle is coated with the coating material which has been uniformly dispersed by dry mixing in advance, even when the battery binding force is small or even when the blending amount of the positive electrode active material particles is high, excellent electronic conductivity and lithium ion conductivity can be achieved, and the resistance can be reduced.

(8) A positive electrode including the positive electrode composite active material particle as described in any one of (1) to (6) is provided.

The positive electrode as described in (8) includes a positive electrode composite active material particle in which at least a part of the surface is coated with a coating material including sulfide solid electrolyte. Thus, even when the battery binding force is small or even when the blending amount of the positive electrode active material particles is high, it is possible to provide positive electrode in which the resistance can be reduced.

(9) A solid-state battery including the positive electrode as described in (8) is provided.

With the solid-state battery as described in (9), even when the battery binding force is small or even when the blending amount of the positive electrode active material particles is high, it is possible to provide a solid-state battery in which the resistance can be reduced.

The present invention can provide a positive electrode composite active material particle capable of reducing resistance even when a battery binding force is small or even when a blending amount of the positive electrode active material particles is high, and a method for producing the positive electrode composite active material particle, a positive electrode including the positive electrode composite active material particle, and a solid-state battery including the positive electrode.

### BRIEF DESCRIPTION OF THE DRAWINGS

FIG. 1 is a schematic view showing a configuration of a positive electrode composite active material particle according to one embodiment of the present invention;

FIG. 2 is a cross-sectional TEM image of the positive electrode composite active material particle according to the embodiment;

FIG. 3 is a cross-sectional SEM image of the positive electrode composite active material particle according to the embodiment;

FIG. 4 is a cross-sectional SEM image of a conventional positive electrode composite active material particle;

FIG. 5 is a schematic view showing a configuration of a positive electrode composite active material particle according to Example 1;

FIG. 6 is a particle surface SEM image of the positive electrode composite active material particle according to Example 1;

FIG. 7 is a schematic view showing a configuration of a positive electrode composite active material particle according to Example 2;

FIG. 8 is a particle surface SEM image of the positive electrode composite active material particle according to Example 2;

FIG. 9 is a schematic view showing a configuration of a positive electrode composite active material particle according to Example 3;

FIG. 10 is a particle surface SEM image of the positive electrode composite active material particle according to Example 3;

FIG. 11 is a schematic view showing a configuration of a positive electrode composite active material particle according to Example 12;

FIG. 12 is a particle surface SEM image of the positive electrode composite active material particle according to Example 12;

FIG. 13 is a schematic view showing a configuration of a positive electrode composite active material particle according to Example 13;

FIG. 14 is a particle surface SEM image of the positive electrode composite active material particle according to Example 13;

FIG. 15 is a schematic view showing a configuration of a positive electrode composite active material particle according to Example 14;

FIG. 16 is a particle surface SEM image of the positive electrode composite active material particle according to Example 14;

FIG. 17 is an area ratio image analysis view of sulfide solid electrolyte according to Example 1;

FIG. 18 is an area ratio image analysis view of sulfide solid electrolyte according to Example 12;

FIG. 19 is a graph showing initial charge/discharge curves at the time when a battery binding force is 60 MPa according to Examples 2 and 12;

FIG. 20 is a graph showing initial charge/discharge curves at the time when a battery binding force is 10 MPa according to Examples 11 and 15;

FIG. 21 is a Nyquist diagram of the positive electrode composite active material particles at 50% SOC according to Examples 12 and 15;

FIG. 22 is a Nyquist diagram of the positive electrode composite active material particles at 50% SOC according to Examples 2 and 11;

FIG. 23 is a graph showing initial charge/discharge curves of positive electrode composite active material particle according to Examples 12 and 17; and

FIG. 24 is a graph showing initial charge/discharge curves of positive electrode composite active material particle according to Examples 2 and 10.

### DETAILED DESCRIPTION OF THE INVENTION

Hereinafter, one embodiment of the present invention will be described in detail with reference drawings.

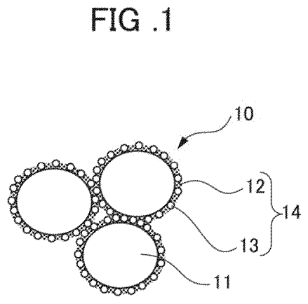

FIG. 1 is a schematic view showing a configuration of a positive electrode composite active material particle 10 according to one embodiment of the present invention. The positive electrode composite active material particle 10 according to the embodiment includes positive electrode active material particles 11, sulfide solid electrolyte 12, conductive auxiliary agent 13, and a coating material 14 including the sulfide solid electrolyte 12 and conductive auxiliary agent 13. As shown in FIG. 1, at least a part of the surface of the positive electrode active material particle 11 is coated with coating material 14 including the sulfide solid electrolyte 12 and the conductive auxiliary agent 13.

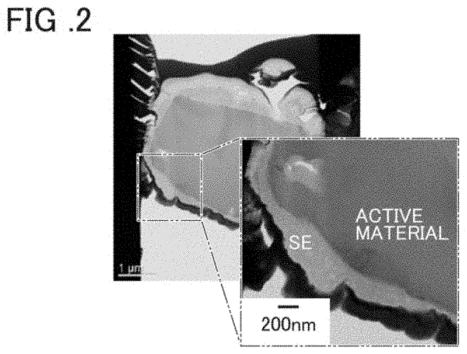

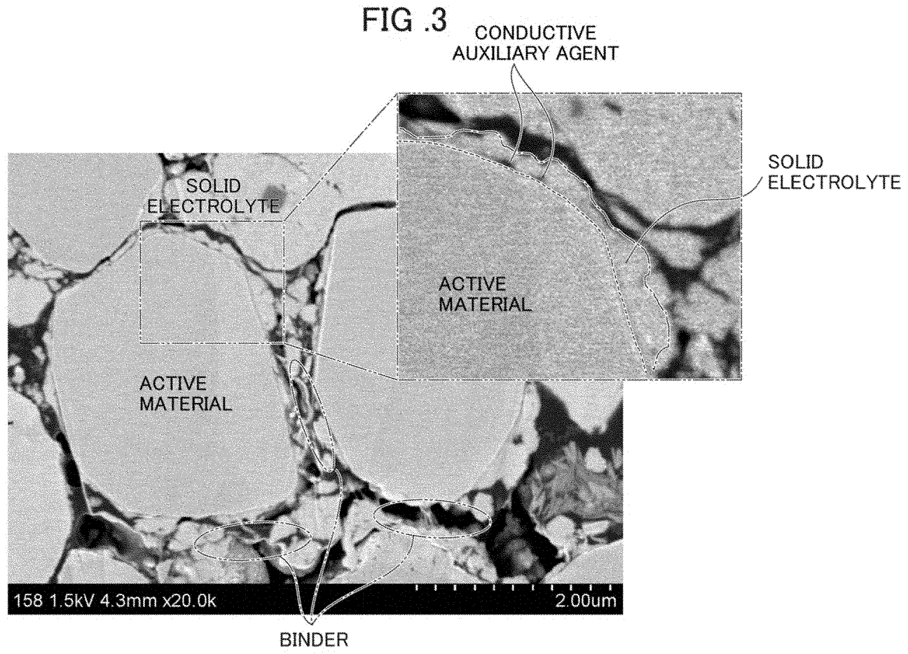

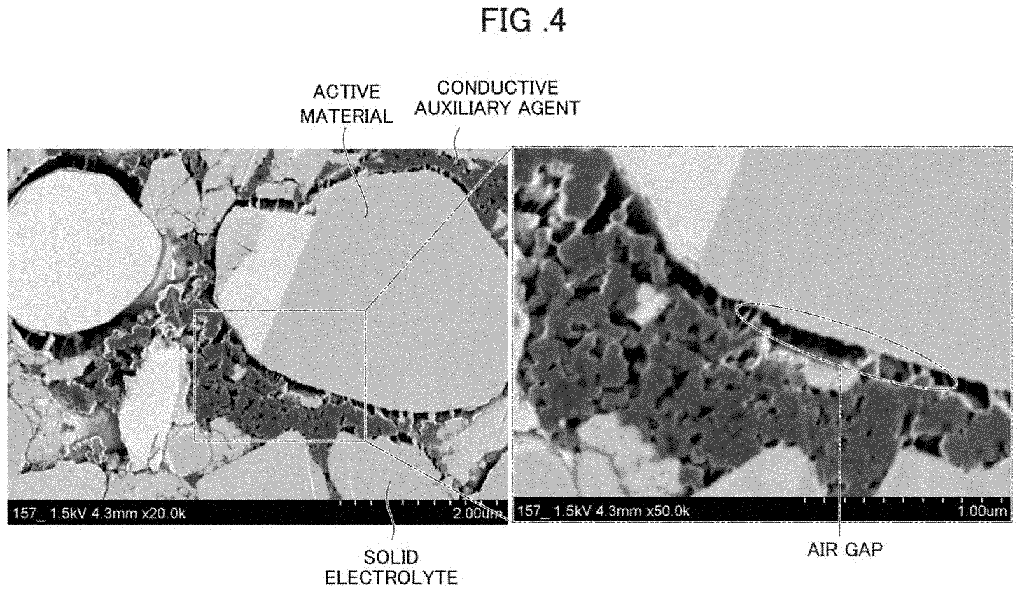

Herein, FIG. 2 is a cross-sectional TEM image of the positive electrode composite active material particle 10 according to the embodiment. FIG. 3 is a cross-sectional SEM image of the positive electrode composite active material particle 10 according to the embodiment. FIG. 4 is a cross-sectional SEM image of a conventional positive electrode composite active material particle. As is apparent from FIG. 4, a conventional positive electrode composite active material particle includes many air gaps in an interface between the surface of each positive electrode active material particle and the solid electrolyte. On the contrary, in the positive electrode composite active material particle 10 according to the embodiment, surface of each positive electrode active material particle 11 is coated with the coating material 14 including the sulfide solid electrolyte 12, and no air gap is observed in the interface therebetween. Thus, in the embodiment, it is characterized that a contact area between each positive electrode active material particle 11 and the sulfide solid electrolyte 12 is sufficiently secured.

Each positive electrode active material particle 11 of the embodiment is made of a lithium-containing oxide, and preferably is a lithium composite oxide. The lithium composite oxide is a transition metal oxide including lithium, and is the active material generating a noble potential with respect to a lithium metal when a battery is configured using lithium as a counter electrode. In other words, it is important that the oxide include lithium, and does not particularly depend on composition or crystal structure.

The shape of the positive electrode active material particles 11 is preferably a shape with little unevenness from the viewpoint that the coating with the coating material 14 described later becomes easy by dry mixing. Among them, a primary particle shape is more preferable than a secondary particle shape being an aggregate of primary particles.

Specific examples of the positive electrode active material particle 11 include layered positive electrode active material particles such as LiCoO₂, LiNiO₂, LiCo_{1/3}Ni_{1/3}Mn_{1/3}O₂, LiVO₂, LiCrO₂, spinel type positive electrode active materials such as LiMn₂O₄, Li (Ni_{0.25}Mn_{0.75})₂O₄, LiCoMnO₄, and Li₂NiMn₃O₃, and olivine type positive electrode active material such as LiCoPO₄, LiMnPO₄, LiFePO₄, and the like. Among them, a composite oxide having a layered rock-salt structure including any element of Ni, Co, and Mn is preferable.

It is preferable that the surface of the positive electrode active material particle 11 is coated with an oxide such as LiNbO₃. This suppresses reaction between the sulfide solid electrolyte 12 and the positive electrode active material particle 11 when the surface of each positive electrode active material particle 11 is coated with the below-mentioned sulfide solid electrolyte 12. In other words, this oxide coating layer such as LiNbO₃ functions as a reaction suppressing layer for suppressing the reaction between the sulfide solid electrolyte 12 and the positive electrode active material particle 11.

The coating with the above-mentioned reaction suppression layer is carried out, for example, as follows. Firstly, a precursor solution of the reaction suppression layer is prepared. For example, LiOC₂H₅ is dissolved in an ethanol solvent such that predetermined amounts of ethoxylithium LiOC₂H⁵ and pentaethoxyniobium Nb(OC₂H₅)₅ are respectively included in ethanol, and then Nb(OC₂H₅)₅ is added and dissolved therein to prepare a precursor solution of the LiNbO₃ reaction suppression layer.

Next, coating of a reaction suppression layer precursor solution to the active material is carried out using, for example, a rolling flow coating device. Li_{1.15}Ni_{0.33}Co_{0.33}Mn_{0.33}O₂ particles as a lithium transient metal composite oxide particles are put in the rolling flow coating device, and while the positive electrode active material particles are rolled up by dry air to circulate in the rolling flow coating device, the precursor solution is sprayed to obtain a positive electrode active material powder body coated with a precursor of the LiNbO₃ reaction suppression layer.

Next, the positive electrode active material powder body coated with the precursor of the LiNbO₃ reaction suppression layer is heat-treated in air in an electric furnace, and a positive electrode active material particle coated with LiNbO₃ reaction suppression layer is obtained.

The sulfide solid electrolyte 12 usually contains a metallic element (M) as conducting ions and sulfur (S). Examples of M include Li, Na, K, Mg, Ca, and the like. In the embodiment where Li ionic conductivity is required, M is Li. In particular, the sulfide solid electrolyte 12 in the embodiment preferably contains Li, A (A is at least one selected from the group consisting of P, Si, Ge, Al, and B), and S. Furthermore, A is preferably P (phosphorus). Furthermore, the sulfide solid electrolyte 12 may include halogen such as Cl, Br, and I from the view point of improving the ionic conductivity. Furthermore, the sulfide solid electrolyte 12 may contain O (oxygen).

Examples of the sulfide solid electrolyte 12 having Li ionic conductivity of the embodiment include Li₂S—P₂S₅, Li_{P}S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are a positive number; Z is any of Ge, Zn, and Ga), Li₂S—GeS₂, Li₂S—SiS₂—Li₃PO₄, Li₂S—SiS₂-LiₓMO_{y} (wherein x and y are a positive number; M is any of P, Si, Ge, B, Al, Ga, and In), and the like. Note here that “Li₂S—P₂S₅” described above means sulfide solid electrolyte using raw material composition including Li₂S and P₂S₅, and the same is true to the other description.

In a case where the sulfide solid electrolyte 12 uses a raw material composition containing Li₂S and P₂S, the rate of Li₂S with respect to the total of Li₁S and P₂S₅ is preferably, for example, in a range of 70 mol % to 80 mol %, more preferably in a range of 72 mol % to 78 mol %, and further preferably in a range of 74 mol % to 76 mol %. This is preferable because sulfide solid electrolyte including an ortho composition or compositions in the vicinity of the ortho composition can be achieved, and sulfide solid electrolyte having high chemical stability can be achieved. Herein, the ortho generally refers to an oxo acid having the highest degree of hydration among oxo acids obtained by hydration of the same oxide. In this aspect, the crystal composition to which Li S is added most in sulfide is referred to as an ortho composition. In the Li₂S—P₂S₅ system, Li₃PS₄ corresponds to the ortho composition. In the case of the sulfide solid electrolyte of Li₂S—P₂S₅ system, the ratio of Li₂S and P₂S₅ to obtain the ortho composition is Li₂S:P₂S₅=75:25 on the molar basis. Note here that also when Al₂S₃ or B₂S₃ is used instead of P₂S₅ in the above-mentioned raw material composition, the preferable range is the same. In the Li₂S—Al₂S₃ system, Li₃AlS₃ corresponds to the ortho composition. In the Li₂S—B₂S₃ system, Li₃BS₃ corresponds to the ortho composition.

In a case where the sulfide solid electrolyte 12 uses a raw material composition containing Li₂S and SiS₂, the rate of Li₂S with respect to the total of Li₂S and SiS₂ is preferably, for example, in a range of 60 mol % to 72 mol %, more preferably in a range of 62 mol % to 70 mol %, and further preferably in a range of 64 mol % to 68 mol %. This is preferable because sulfide solid electrolyte including an ortho composition or compositions in the vicinity of the ortho composition can be achieved, and sulfide solid electrolyte having high chemical stability can be achieved. In the Li₂S—SiS₂ system, Li₄SiS₄ corresponds to the ortho composition. In the case of the sulfide solid electrolyte of Li₂S—SiS₂ system, the ratio of Li₂S and SiS₂ to obtain the ortho composition is Li₁S:SiS₂-66.6:33.3 on the molar basis. Note here that also when GeS₂ is used instead of SiS₂ in the above-mentioned raw material composition, the preferable range is the same. In the Li₂S—GeS₂ system, Li₄GeS₄ corresponds to the ortho composition.

In a case where the sulfide solid electrolyte 12 uses a raw material composition containing LiX (X=Cl, Br, and I), the rate of LiX is preferably, for example, in a range of 1 mol % to 60 mol %, more preferably in a range of 5 mol % to 50 mol %, and further preferably in a range of 10 mol % to 40 mol %.

Furthermore, the sulfide solid electrolyte 12 may be sulfide glass or crystallized sulfide glass, or a crystalline material obtained by the solid phase method. Note here that the sulfide glass can be obtained, for example, by subjecting the raw material composition to mechanical milling (ball milling, and the like). Furthermore, the crystallized sulfide glass can be obtained, for example, by heat-treating the sulfide glass at a temperature that is the crystallization temperature or higher. The Li ionic conductivity of the sulfide solid electrolyte 12 at ordinary temperature is, for example, preferably 1×10⁻⁴ S/cm or more, and further preferably 1×10⁻³ S/cm or more.

The coating material 14 of the embodiment has a feature in that the above-described sulfide solid electrolyte 12 is included. Furthermore, the coating material 14 preferably includes a conductive auxiliary agent 13.

As the conductive auxiliary agent 13, a conventionally known conductive auxiliary agent can be used. Specific examples of the conductive auxiliary agent 13 include acetylene black, natural graphite, artificial graphite, and the like.

A value of D/t is preferably in a range of 9.0 to 150 when D (nm) is the particle diameter D50 of the positive electrode active material particle 11 and t (nm) is an average thickness of the coating material 14. When the value of D/t is in this range, in the interface between the positive electrode active material particle 11 and the coating material 14, the electron path and the lithium ion path is sufficiently formed, and even when a battery binding force is small or even when a blending amount of the positive electrode active material particles is high, resistance can be reduced. Further preferable value of D/t is 12 to 84.6, and a preferable value of D/t is 16 to 50.6.

Herein, the particle diameter D50 of the positive electrode active material particle 11 is preferably 1.2 μm to 10.5 μm. When the particle diameter D50 of the positive electrode active material particle 11 is in this range, the above-described resistance reduction effect can be achieved more reliably. More preferable particle diameter D50 is 2.5 μm to 7.2 μm, and further preferable particle diameter D50 is 3.0 μm to 6.0 μm.

Furthermore, in the positive electrode composite active material particle 10 of the embodiment, in a cross-sectional image thereof, a rate of an area of the sulfide solid electrolyte 12 in a region at a distance of t (nm) or less from the surface of the positive electrode active material particle 11 with respect to an entire area of the region is preferably 40% or more. When the rate of the sulfide solid electrolyte 12 in the region is in this range, formation of air gaps in the interface between the positive electrode active material particle 11 and the coating material 14 is suppressed, and a large contact area between the positive electrode active material particle 11 and the sulfide solid electrolyte 12 is secured. Accordingly, even when the battery binding force is small or even when the blending amount of the positive electrode active material particles 11 is high, resistance can be reduced.

Next, a method for producing a positive electrode composite active material particle 10 according to the embodiment is described. The method for producing a positive electrode composite active material particle 10 according to the embodiment includes a mixing step of dry mixing a positive electrode active material particle 11, and a coating material including sulfide solid electrolyte 12 and preferably a conductive auxiliary agent 13.

In this mixing step, by shear stress generated by dry mixing, entire surface or a part of the surface of each positive electrode active material particle 11 is coated with the coating material 14. In particular, in the case of the coating material 14 including the conductive auxiliary agent 13 in addition to the sulfide solid electrolyte 12, entire surface or a part of the surface of each positive electrode active material particle 11 is coated with the coating material 14 which has been uniformly dispersed by dry mixing in advance.

The time for dry mixing depends on the amount and particle size of the sulfide solid electrolyte to be coated, but, for example, is desirably 30 minutes, and more desirably 60 minutes in that the sulfide solid electrolyte does not become excessively amorphous. Furthermore, for example, the rotation speed is desirably 100 rpm, and more desirably 120 rpm in that the sulfide solid electrolyte does not become excessively amorphous.

The positive electrode composite active material particle 10 and a method for producing the same according to the embodiment can achieve the following effect. In the positive electrode composite active material particle 10 of the embodiment, at least a part of the surface of the positive electrode active material particle 11 made of a lithium-containing oxide is coated with a coating material 14 including sulfide solid electrolyte 12. Accordingly, coating of the positive electrode active material particles 11 with the sulfide solid electrolyte 12 can suppress generation of air gaps in the interface between each positive electrode active material particle 11 and the sulfide solid electrolyte 12, and the resistance can be reduced. In particular, since generation of gaps in the interface between each positive electrode active material particle 11 and the sulfide solid electrolyte 12 can be suppressed, even when a battery binding force is small or even in a case of a high energy density battery having a high blending amount of the positive electrode active material particles 11, the resistance can be reduced.

Furthermore, in the positive electrode composite active material particle 10 of the embodiment, at least a part of the surface of the positive electrode active material particle 11 made of lithium-containing oxide is coated with the coating material 14 including the sulfide solid electrolyte 12 and the conductive auxiliary agents 13. In other words, the presence of the conductive auxiliary agent 13 in the interface between each positive electrode active material particle 11 and the sulfide solid electrolyte 12, the electronic conductivity can be ensured, and accordingly, the resistance can be reduced. In particular, even when a battery binding force is small or even in a case of a high energy density battery having an increased rate of the positive electrode active material particle 11, since the electron path and the lithium ion path in the interface between each positive electrode active material particle 11 and coating material 14 can be sufficiently formed, the increase in resistance can be avoided.

Furthermore, in the positive electrode composite active material particle 10 of the embodiment, a value of D/t is in a range of 9.0 to 150 where D (nm) is a particle diameter DSO of the positive electrode active material particle 11 and t (nm) is an average thickness of the coating material 14. Thus, in the interface between each positive electrode active material particle 11 and the coating material 14, the electron path and the lithium ion path can be sufficiently formed. Even when the battery binding force is small or even when the blending amount of the positive electrode active material particles 11 is high, the resistance can be reduced.

Furthermore, in the positive electrode composite active material particle 10 of the embodiment, in a cross-sectional image of the positive electrode composite active material particle 10, a rate of an area of the sulfide solid electrolyte 12 in a region at a distance of t (nm) or less from the surface of the positive electrode active material particle 11 with respect to an entire area of the region is 40% or more. Thus, formation of air gaps in the interface between each positive electrode active material particle 11 and the coating material 14 is suppressed, and a large contact area between the positive electrode active material particles 11 and the sulfide solid electrolyte 12 can be secured. Accordingly, even when the battery binding force is small or even when the blending amount of the positive electrode active material particles 11 is high, the resistance can be reduced.

Furthermore, in the positive electrode composite active material particle 10 of the embodiment, the positive electrode active material particle 11 is made of lithium composite oxide. Thus, when the battery binding force is small or even when the blending amount of the positive electrode active material particles 11 is high, excellent electronic conductivity and lithium ion conductivity can be achieved, and the resistance can be reduced.

Furthermore, in the positive electrode composite active material particle 10 of the embodiment, the positive electrode active material particle 11 is made of composite oxide having a layered rock-salt structure including any element of Ni, Co, and Mn. Thus, even when the battery binding force is small or even when the blending amount of the positive electrode active material particles is high, more excellent electronic conductivity and lithium ion conductivity can be achieved, and resistance can be reduced.

Furthermore, a method for producing the positive electrode composite active material particle 10 according to the embodiment includes a mixing step of dry mixing the positive electrode active material particles 11 and the coating material including the sulfide solid electrolyte 12. By shear stress generated by dry mixing, positive electrode composite active material particles 10 in which at least a part of the surface is coated with the coating material 14 including the sulfide solid electrolyte 12 can be produced. In particular, when the coating material 14 including a conductive auxiliary agent 13 in addition to the sulfide solid electrolyte 12 is used, since the surface of the positive electrode active material particle 11 is coated with the coating material 14 which has been uniformly dispersed by dry mixing in advance, even when the battery binding force is small or even when the blending amount of the positive electrode active material particles 11 is high, excellent electronic conductivity and lithium ion conductivity can be achieved, and the resistance can be reduced.

Next, a positive electrode including the positive electrode composite active material particle 10 according to the embodiment, and a solid-state battery including the positive electrode are described. The positive electrode according to the embodiment is characterized by including the above-described positive electrode composite active material particle 10 according to the embodiment. The positive electrode according to the embodiment is configured to include a conductive auxiliary agent, a binder, a solid electrolyte, and the like, which are all conventionally known, other than the positive electrode composite active material particle 10.

The positive electrode including the positive electrode composite active material particle 10 according to the embodiment is produced by conventionally known production methods. Specifically, the positive electrode can be produced by preparing positive electrode slurry including positive electrode active material particles 11, and then coating a current collector with the positive electrode slurry and drying thereof.

Furthermore, the solid-state battery according to the embodiment is characterized by including a positive electrode including the positive electrode composite active material particle 10 according to the embodiment described above. As the negative electrode and the solid electrolyte, conventionally known one can be used, and as the method for producing thereof, conventionally known production methods can be employed.

With a positive electrode including the positive electrode composite active material particle 10 according to the embodiment, and a solid-state battery including the positive electrode, the same effect as the above-described positive electrode composite active material particle 10 according to the embodiment can be achieved.

Note here that the present invention is not limited to the above-mentioned embodiment, and modifications and improvements within a scope that can achieve the object of the present invention are included in the present invention.

### EXAMPLES

Next, Examples of the present invention will be described, but the present invention is not to be limited thereto.

### Example 1

[Production of positive electrode composite active material particle]A ternary system positive electrode active material particle and sulfide solid electrolyte in a mass ratio of 90:10 were weighed in total 40 g in a glove box with a dew point controlled. Next, the weighed products together with 100 ZrO₂ balls each having 910 mm were dry mixed using a planetary ball mill. As the mixing conditions, the rotation speed was 120 rpm, and time was one hour. The mixed powder after dry mixing was taken out from a ball mill container, and allowed to pass through a sieve having a mesh size of 100 μm to obtain a positive electrode composite active material particle.

Note here that a positive electrode active material particle was produced as follows.

### (Seed Forming Step)

A 25% by mass aqueous sodium hydroxide solution was added to water in a reaction tank, and the pH value of the solution in the tank was adjusted to 13.5 or higher. Next, a nickel sulfate solution, a cobalt sulfate solution, and a manganese sulfate solution were mixed with each other to prepare a mixed aqueous solution having a molar ratio of 1:1:1. The mixed aqueous solution was added until the solute content reached 4 mol, and seed formation was carried out while the pH value of the reaction solution was controlled to 12.0 or higher with a sodium hydroxide solution.

### (Crystallization Step)

After the seed forming step described above, until the crystallization step was completed, the pH value of the reaction solution was controlled with a sodium hydroxide solution such that the value was maintained in the range of 10.5 to 12.0. Sampling was successively performed during the reaction, and the addition was completed when D₅₀ of the composite hydrozide particles reached about 3.0 μm. Next, the product was washed with water, filtered, and dried to obtain composite hydroxide particle. The obtained hydroxide precursor was subjected to a heat treatment at 300° C. for 20 hours in the ambient atmosphere, thereby obtaining composite oxides having the following composition ratio: Ni/Co/Mn =0.33/0.33/0.33, respectively.

### (Synthesis Step)

The obtained composite oxide and lithium carbonate were mixed so that Li/(Ni+Co+Mn) became 1.05 to obtain a raw material mixture. The obtained raw material mixture was calcined in air at 925° C. for 7.5 hours and then calcined at 1030° C. for 6 hours to obtain a sintered product. The obtained sintered product was crushed, subjected to a dispersion treatment in a ball mill made of resin for 30 minutes, and then dry-sieved to obtain a powder body. The obtained powder body and lithium carbonate were mixed so that Li/(Ni+Co+Mn) became 1.17, and the obtained product was calcined in air at 900° C. for 10 hours to obtain a sintered product. The obtained sintered product was crushed, subjected to a dispersion treatment in a ball mill made of resin for 30 minutes.

As mentioned above, as shown in Table 1, using an air classifier, a lithium transient metal composite oxide particle represented by the composition formula: Li_{1.15}Ni_{0.33}Co_{0.33}Mn_{0.33}O₂ having average particle diameters D50 of 1.2 μm, 3.5 μm, 7.0 μm, and 10.5 μm were obtained, respectively.

### (Coating Step of Reaction Suppression Layer)

Firstly, a precursor solution of a LiNbO₃ reaction suppression layer was prepared. LiOC₂H₅ was dissolved in an ethanol solvent such that 1.0 mol/L of ethoxylithium LiOC₂H₅ and pentaethoxyniobium Nb(OC₂H₅)₅ were included in ethanol, respectively, then Nb(OC₂H₅)₅ was dissolved therein to prepare a precursor solution of a LiNbO₃ reaction suppression layer.

The coating of the reaction suppression layer precursor solution to the active material was carried out using, for example, a tumbling fluidized coating device. Li_{1.15}Ni_{0.33}Co_{0.33}Mn_{0.33}O₂ particles as lithium transient metal composite oxide particles were placed in a rolling flow coating device, and while the positive electrode active material particles are rolled up by dry air to circulate in the rolling flow coating device, the precursor solution was sprayed to obtain a positive electrode active material powder body coated with a precursor of the LiNbO₃ reaction suppression layer.

The positive electrode active material powder body coated with the precursor of the LiNbO₃ reaction suppression layer was heat-treated at 400° C. for 2 hours in air in an electric furnace. Thus, a positive electrode active material particle coated with LiNbO₃ reaction suppression layer was obtained. In this way, a NCM ternary positive electrode active substance coated with the LiNbO₃ reaction suppression layer was obtained.

Furthermore, the sulfide solid electrolyte was produced as follows.

For example, the sulfide solid electrolyte can be produced by well-known methods as described in the specification of Japanese Patent Application No. 2015-130247. Specifically, Li₂S, P₂S₅, LiI, and LiBr were weighed such that the composition satisfies 10LiI.15LiBr.75 (0.75Li₂S.0.25P₂S₅), and mixed in an agate mortar for 5 minutes. To a planetary ball mill container, 2 g of the above-obtained mixture was put, dehydrated heptane was put, and further ZrO₂ ball was put, and the container was completely sealed. This container was attached to a planetary ball mill machine, and mechanical milling was carried out at a base rotation speed of 500 rpm for 20 hours. Thereafter, heptane was removed by drying at 110° C. for one hour, and sulfide solid electrolyte material as coarse particle material was obtained.

Thereafter, the obtained coarse particle material was made into fine particles. To the coarse particle material, dehydrated heptane and dibutyl ether were mixed, and the obtained mixture was adjusted such that the total amount was 10 g and the solid content concentration was 10 mass %. The obtained mixture was put in the planetary ball mill container, ZrO₂ ball was further put thereto, and the container was completely sealed. This container was attached to a planetary ball mill machine, and mechanical milling was carried out at a base rotation speed of 150 rpm for 20 hours. Thereafter, drying was carried out to obtain amorphous sulfide solid electrolyte material (D50=0.8 μm). The amorphous sulfide solid electrolyte material was calcined at 200° C. to obtain sulfide solid electrolyte material being glass ceramics.

### [SEM Observation]

The obtained positive electrode composite active material particle was subjected to surface SEM observation using SEM “SU8220” manufactured by Hitachi High-Tech Corporation, at an acceleration voltage of 2.0 kV. Furthermore, the obtained positive electrode composite active material particle was embedded with resin, and a test sample for cross-sectional SEM observation was produced using Ar ion under inert atmosphere. The produced test sample was subjected to cross-sectional SEM observation using SEM “SU8220” manufactured by Hitachi High-Tech Corporation, at an acceleration voltage of 2.0 kV.

### [Calculation of Average Thickness t of Coating Material and D/t Value]

In the obtained cross-sectional SEM image, arbitrary 20 positive electrode active material particles were selected, and the average thickness t (nm) of coating material that coats positive electrode active material particles was calculated by measuring a distance from the center distance of the active material to the coating material by image analysis. Furthermore, the D/t value was calculated from D50 particle diameter D (nm) of the used positive electrode active material particle and the average thickness t (nm) of the coating material.

[Calculation of Area Ratio of Sulfide Solid Electrolyte in Region at Distance of t (Nm) or Less from Surface of Positive Electrode Active Material Particle]

Furthermore, in the obtained cross-sectional SEM image, a rate of an area of the sulfide solid electrolyte with respect to an entire area of the region at a distance of t (nm) or less from the surface of the positive electrode active material particles was calculated by reflection electron diffraction. In the calculation, a part with high luminance was used as a solid electrolyte and a part with low luminance was used as a conductive auxiliary agent in the reflection electron diffraction. The calculation was carried out by image analysis.

### [Production of Positive Electrode]

The positive electrode composite active material particle produced as described above, the sulfide solid electrolyte produced as described above similarly, acetylene black as a conductive auxiliary agent, and styrene butadiene rubber (SBR) as a binder were weighed in a mass ratio of 70:27:3:2, in a glove box with a dew point controlled. As the binder, a solution previously dissolved in a butyl butyrate solvent at a concentration of 10 mass % was used. Next, the weighed product was mixed in the conditions at 2000 rpm for 10 minutes using a rotation-revolution mixer to produce positive electrode slurry. For adjusting viscosity of the positive electrode slurry, a butyl butyrate solvent was appropriately added. Next, positive electrode slurry was coated on an aluminum foil using an applicator, and dried on a hot plate at 80° C. for 30 minutes to obtain a positive electrode. A coated amount of the positive electrode mixture material was 21.3 mg/cm².

### [Production of Negative Electrode]

Artificial graphite as a negative electrode active material, the sulfide solid electrolyte produced as described above, and styrene butadiene rubber (SBR) as a binder were weighed in a mass ratio of 65:35:1 in a glove box with dew point controlled. As the binder, a solution previously dissolved in a butyl butyrate solvent at a concentration of 10 mass % was used. Next, the weighed product was mixed in the conditions at 2000 rpm for 10 minutes using a rotation-revolution mixer to produce negative electrode slurry. For adjusting viscosity of the negative electrode slurry, a butyl butyrate solvent was appropriately added. Next, negative electrode slurry was coated on a SUS foil using an applicator, and dried on a hot plate at 80° C. for 30 minutes to obtain a negative electrode. A coated amount of the negative electrode mixture material was 15.0 mg/cm².

### [Production of Solid-State Battery]

The produced positive electrode and negative electrode were respectively cut using a mold of 910 mm. Next, 100 mg of sulfide solid electrolyte powder produced as described above was weighed, and put in a ceramic tube made of zirconia having a through hole of Φ10 mm, and powder-compacted at 200 MPa to obtain an electrolyte layer. Next, the positive electrode and the negative electrode were put from above and below, and pressed at 1000 MPa to obtain a solid-state battery in which the positive electrode, the solid electrolyte layer, and the negative electrode were stacked sequentially.

### [Initial Charge/Discharge Test and DCR Test]

The obtained solid-state battery was sandwiched by metal made of SUS from above and below and bolted to thereby apply pressure of 60 MPa. The produced solid-state battery was subjected to the initial charge/discharge test and the DCR test. The initial charge/discharge test was carried out under conditions at 25° C., and at an electric current value of 0.1 C (0.23 mA/cm). Charge/discharge voltage was in a range of 4.2 V to 2.7 V. The DCR test performs measurement by adjusting SOC to 50% under the conditions at 25° C., and then, discharge was carried out at 0.1 C to 5C for 10 seconds.

### Examples 2 to 6

A positive electrode composite active material particle was produced by the same procedure as in Example 1 except that acetylene black as a conductive auxiliary agent, which was not used in Example 1, constituting the coating material was used. The mass ratio of the positive electrode active material particle, the sulfide solid electrolyte, and the conductive auxiliary agent in each Example was as shown in Table 1. Furthermore, SEM observation, calculation of the average thickness t of the coating material and the D/t value, calculation of an area ratio of the sulfide solid electrolyte in a region at a distance of t (nm) or less from the surface of the positive electrode active material particle, production of the positive electrode, production of the negative electrode, production of the solid-state battery, and the initial charge/discharge test and the DCR test were all carried out in the same manner as in Example 1. In Example 2, alternating current impedance measurement was carried out. Under an environment of 25° C., the SOC was adjusted to 50%, and then the measurement was performed at an AC voltage of 10 mV and a measurement frequency of 1 MHz to 0.1 Hz.

### Examples 7 to 9

As shown in Table 1, a positive electrode composite active material particle was produced by the same procedure as in Example 1 except that positive electrode active material particle having D50 particle diameter D of NCM111 being different from Example 1 was used as the positive electrode active material particle, and acetylene black as a conductive auxiliary agent constituting the coating material, which was not used in Example 1, was used. The mass ratio of the positive electrode active material particle, the sulfide solid electrolyte, and the conductive auxiliary agent in each Example was as shown in Table 1. Furthermore, SEM observation, calculation of the average thickness t of the coating material and the D/t value, calculation of an area ratio of the sulfide solid electrolyte in a region at a distance of t (nm) or less from the surface of the positive electrode active material particle, production of the negative electrode, production of the solid-state battery, and the initial charge/discharge test and the DCR test were all carried out in the same manner as in Example 1.

### Example 10

A positive electrode composite active material particle was produced by the same procedure as in Example 1 except that acetylene black as a conductive auxiliary agent constituting the coating material, which was not used in Example 1, was used. The mass ratio of the positive electrode active material particle, the sulfide solid electrolyte, and the conductive auxiliary agent was as shown in Table 1. The positive electrode was produced in the same manner as in Example 1 except that the mass ratio of the positive electrode composite active material particle, the sulfide solid electrolyte, the conductive auxiliary agent, and the binder was changed to that shown in Table 1. Furthermore, SEM observation, calculation of the average thickness t of the coating material and the D/t value, calculation of an area ratio of the sulfide solid electrolyte in a region at a distance of t (nm) or less from the surface of the positive electrode active material particle, production of the negative electrode, production of the solid-state battery, and the initial charge/discharge test and the DCR test were all carried out in the same manner as in Example 1.

### Example 11

A positive electrode composite active material particle was produced by the same procedure as in Example 1 except that acetylene black as a conductive auxiliary agent, which was not used in Example 1, constituting the coating material was used. The mass ratio of the positive electrode active material particle, the sulfide solid electrolyte, and the conductive auxiliary agent was as shown in Table 1. Furthermore, SEM observation, calculation of the average thickness t of the coating material and the D/t value, calculation of an area ratio of the sulfide solid electrolyte in a region at a distance of t (nm) or less from the surface of the positive electrode active material particles, production of the positive electrode, production of the negative electrode, production of the solid-state battery, were all carried out in the same manner as in Example 1. Note here that the initial charge/discharge test and the DCR test were carried out in the same manner as in Example 1 except that pressure power was changed to 10 MPa. In Example 11, alternating current impedance measurement was carried out. Under an environment of 25° C., the SOC was adjusted to 50%, and then the measurement was performed at an AC voltage of 10 mV and a measurement frequency of 1 MHz to 0.1 Hz.

### Examples 12 to 14

A positive electrode composite active material particle was produced by the same procedure as in Example 1 except that acetylene black as a conductive auxiliary agent, which was not used in Example 1, constituting the coating material was used. The mass ratio of the positive electrode active material particle, the sulfide solid electrolyte, and the conductive auxiliary agent was as shown in Table 1. Furthermore, SEM observation, calculation of the average thickness t of the coating material and the D/t value, calculation of an area ratio of the sulfide solid electrolyte in a region at a distance of t (nm) or less from the surface of the positive electrode active material particle, production of the positive electrode, production of the negative electrode, production of the solid-state battery, and the initial charge/discharge test and the DCR test were all carried out in the same manner as in Example 1. In Example 12, alternating current impedance measurement was carried out. Under an environment of 25° C., the SOC was adjusted to 50%, and then the measurement was performed at an AC voltage of 10 mV and a measurement frequency of 1 MHz to 0.1 Hz.

### Example 15

A positive electrode composite active material particle was produced by the same procedure as in Example 1 except that acetylene black as a conductive auxiliary agent, which was not used in Example 1, constituting the coating material was used. The mass ratio of the positive electrode active material particle, the sulfide solid electrolyte, and the conductive auxiliary agent was as shown in Table 1. Furthermore, SEM observation, calculation of the average thickness t of the coating material and the D/t value, calculation of an area ratio of the sulfide solid electrolyte in a region at a distance of t (nm) or less from the surface of the positive electrode active material particles, production of the positive electrode, production of the negative electrode, production of the solid-state battery, were all carried out in the same manner as in Example 1. Note here that the initial charge/discharge test and the DCR test were carried out in the same manner as in Example 1 except that pressure power was changed to 10 MPa. In Example 15, alternating current impedance measurement was carried out. Under an environment of 25° C., the SOC was adjusted to 50%, and then the measurement was performed at an AC voltage of 10 my and a measurement frequency of 1 MHz to 0.1 Hz.

### Examples 16 to 17

A positive electrode composite active material particle was produced by the same procedure as in Example 1 except that acetylene black as a conductive auxiliary agent, which was not used in Example 1, constituting the coating material was used. The mass ratio of the positive electrode active material particle, the sulfide solid electrolyte, and the conductive auxiliary agent was as shown in Table 1. The positive electrode was produced in the same manner as in Example 1 except that the mass ratio of the positive electrode composite active material particle, the sulfide solid electrolyte, the conductive auxiliary agent, and the binder was changed to that shown in Table 1. Furthermore, SEM observation, calculation of the average thickness t of the coating material and the D/t value, calculation of an area ratio of the sulfide solid electrolyte in a region at a distance of t (nm) or less from the surface of the positive electrode active material particle, production of the negative electrode, production of the solid-state battery, and the initial charge/discharge test and the DCR test were all carried out in the same manner as in Example 1.

### Example 18

Acetylene black as a conductive auxiliary agent, which was not used in Example 1, constituting the coating material was used. Unlike Example 1, conditions of dry mixing of a planetary ball mill were changed. As the conditions, the rotation speed was 120 rpm, and mixing time was 24 hours. Other procedures were the same, and the positive electrode composite active material particle was produced. The mass ratio of the positive electrode active material particle, the sulfide solid electrolyte, and the conductive auxiliary agent was as shown in Table 1. The positive electrode was produced in the same manner as in Example 1 except that the mass ratio of the positive electrode composite active material particle, the sulfide solid electrolyte, the conductive auxiliary agent, and the binder was changed to that shown in Table 1. Furthermore, SEM observation, calculation of the average thickness t of the coating materials and the D/t value, calculation of an area ratio of the sulfide solid electrolyte in a region at a distance of t (nm) or less from the surface of the positive electrode active material particle, production of the negative electrode, production of the solid-state battery, and the initial charge/discharge test and the DCR test were all carried out in the same manner as in Example 1.

### Example 19

A positive electrode composite active material particle was produced by the same procedure as in Example 1 except that a positive electrode active material on which coating of a reaction suppression layer was not formed, which was not used in Example 1, was used. The mass ratio of the positive electrode active material particle, the sulfide solid electrolyte, and the conductive auxiliary agent was as shown in Table 1. Furthermore, SEM observation, calculation of the average thickness t of the coating material and the D/t value, calculation of an area ratio of the sulfide solid electrolyte in a region at a distance of t (nm) or less from the surface of the positive electrode active material particle, production of the negative electrode, production of the solid-state battery, and the initial charge/discharge test and the DCR test were all carried out in the same manner as in Example 1.

Blending and evaluation results of each Example are summarized in Table 1.

TABLE 1

| | | | | | | | Positive | | |
|---|---|---|---|---|---|---|---|---|---|
| | Positive electrode composite active material particle | | | | | | electrode | | |
| | | | | | | Are rate of | Active | | |
| | | Active | | | | solid | material: | | |
| | | material: | | | | electrolyte in | solid | | |
| | | solid | D50 | | | region at | electrolyte: | | |
| | Presence or | electrolyte: | particle | Average | | distance of t | conductive | | |
| | absence of | conductive | diameter | thickness | | nm or less | auxiliary | Solid battery | |
| | reaction | auxiliary | D of active | of solid | | from active | agent: | | Binding |
| | suppression | agent (Mass | material | electrolyte | | material | binder (Mass | Resistance | Force |
| | layer | ratio) | (μm) | (nm) | D/t | Surface (%) | ratio) | (Ω · cm²) | (MPa) |
| Example 1 | Presence | 90:10:0 | 3.5 | 140 | 25 | 84 | 70:27:3:2 | 26 | 60 |
| Example 2 | Presence | 90:9.9:0.1 | 3.5 | 140 | 25 | 70 | 70:27:3:2 | 23.9 | 60 |
| Example 3 | Presence | 90:9.5:0.5 | 3.5 | 140 | 25 | 62 | 70:27:3:2 | 24.2 | 60 |
| Example 4 | Presence | 87:12.8:0.2 | 3.5 | 185 | 19 | 81 | 70:27:3:2 | 24.5 | 60 |
| Example 5 | Presence | 75:24.5:0.5 | 3.5 | 372 | 9.4 | 76 | 70:273:2 | 29 | 60 |
| Example 6 | Presence | 95:4.9:0.1 | 3.5 | 69 | 50.6 | 59 | 70:27.3:2 | 25 | 60 |
| Example 7 | Presence | 90:9.9:0.1 | 7.0 | 280 | 25 | 86 | 70:27:3:2 | 25.5 | 60 |
| Example 8 | Presence | 90:9.9:0.1 | 10.5 | 420 | 25 | 90 | 70:27:3:2 | 28.2 | 60 |
| Example 9 | Presence | 90:9.9:0.1 | 1.2 | 48 | 25 | 58 | 70:27:3:2 | 27.4 | 60 |
| Example 10 | Presence | 90:9.9:0.1 | 3.5 | 140 | 25 | 70 | 85:13:2:2 | 34.3 | 60 |
| Example 11 | Presence | 90:9.9:0.1 | 3.5 | 140 | 25 | 70 | 70:27:3:2 | 33.5 | 10 |
| Example 12 | Presence | 98.3:1.6:0.1 | 3.5 | 50 | 70 | 38 | 70:27:3:2 | 61 | 60 |
| Example 13 | Presence | 75:24:1 | 3.5 | 424 | 8.3 | 66 | 70:27:3:2 | 48 | 60 |
| Example 14 | Presence | 90:8.8:1.2 | 3.5 | 140 | 25 | 20 | 70:27:3:2 | 71.7 | 50 |
| Example 15 | Presence | 98.3:1.6:0.1 | 3.5 | 50 | 70 | 38 | 70:27:3:2 | 84 | 10 |
| Example 16 | Presence | 90:8.8:1.2 | 3.5 | 140 | 25 | 20 | 85:13:2:2 | 140.1 | 60 |
| Example 17 | Presence | 98.3:1.0:0.1 | 3.5 | 50 | 70 | 38 | 85:13:2:2 | 106 | 60 |
| Example 18 | Presence | 98.3:1.6:0.1 | 3.5 | 23 | 152 | 70 | 70:27:3:2 | 33.3 | 60 |
| Example 19 | Absence | 90:10:0 | 3.5 | 140 | 25 | 80 | 70:27:3:2 | 60 | 60 |

### <Consideration>

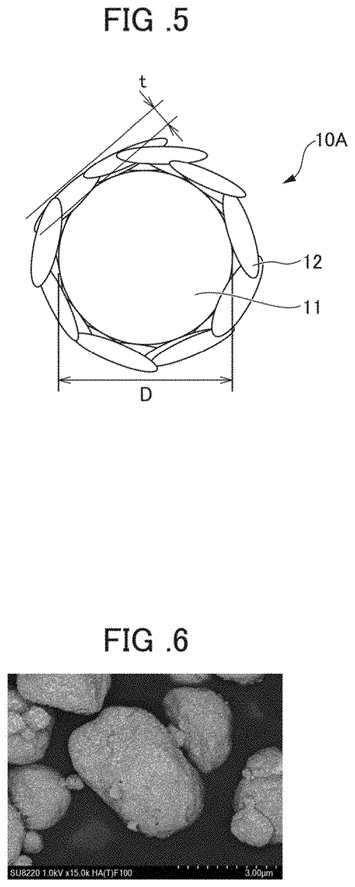

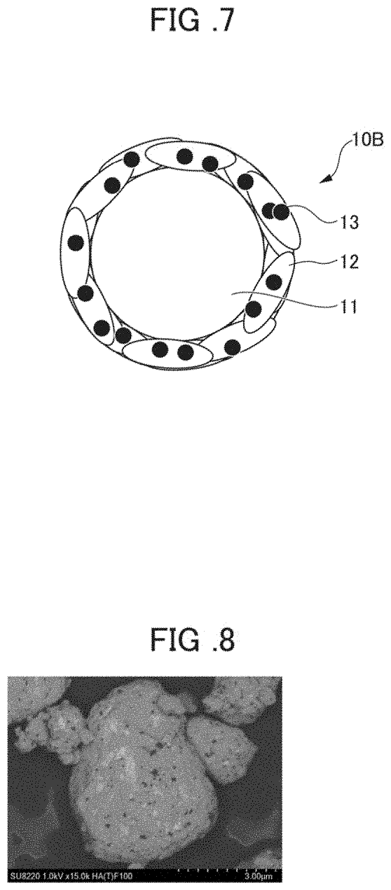

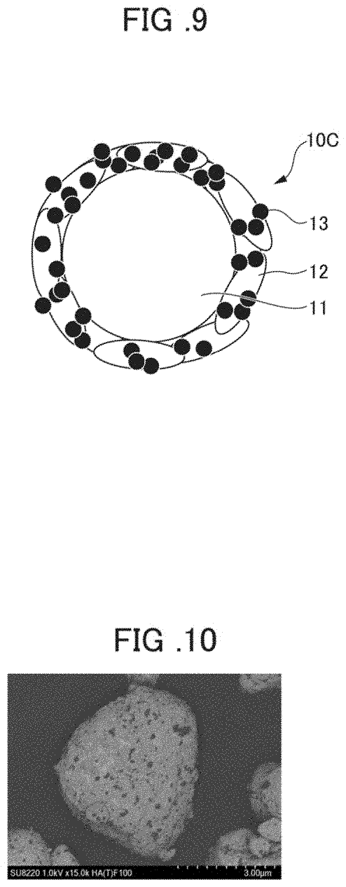

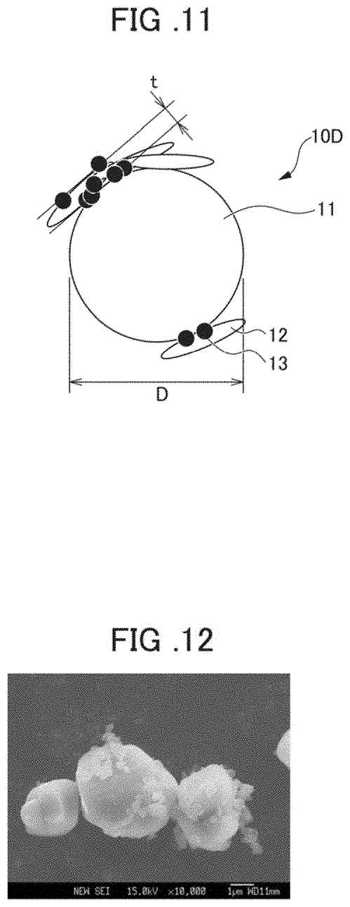

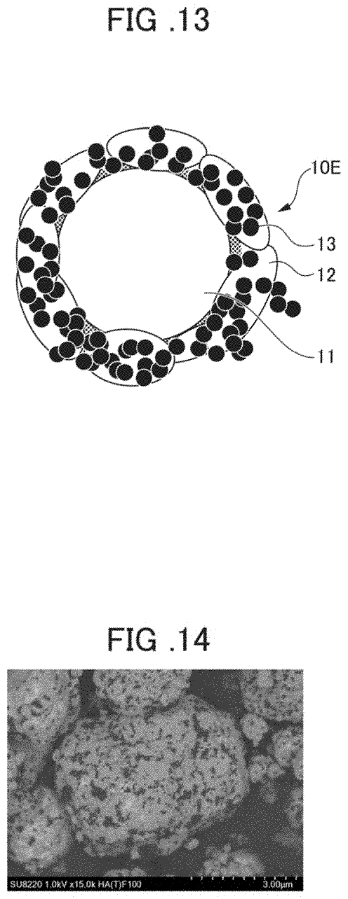

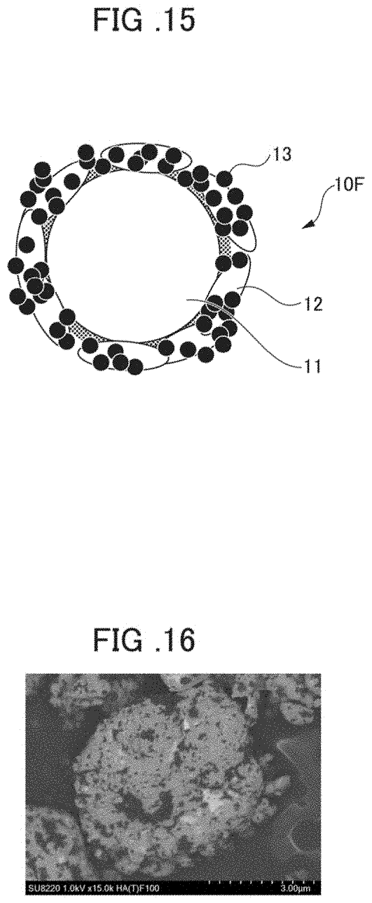

FIGS. 5 to 16 are a schematic view and particle surface SEM image showing a configuration of each positive electrode composite active material particle of Examples 1 to 3, 12 to 14. From these FIGS. 5 to 16, in these Examples, at least a part of the surface of the positive electrode active material particle made of a lithium-containing oxide is coated with a coating material including sulfide solid electrolyte.

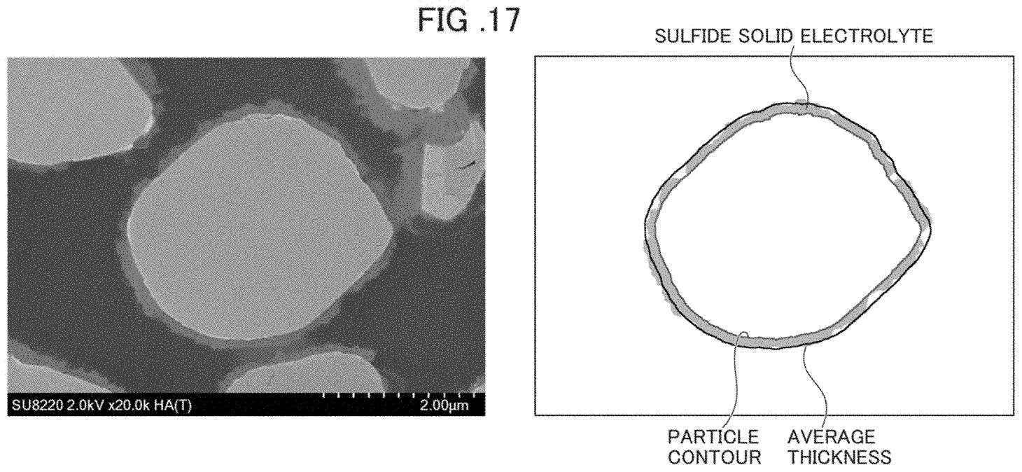

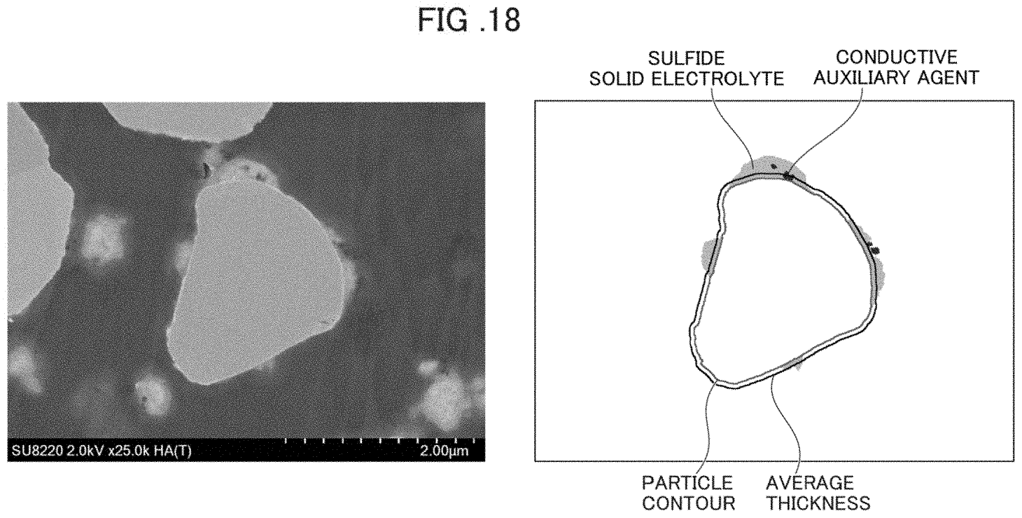

FIGS. 17 and 18 are area ratio image analysis views of sulfide solid electrolyte of Examples 1 and 12, respectively. The area ratio image analysis views of FIGS. 17 and 18 show a contour of particle and a line of an average thickness t of sulfide solid electrolyte in correspondence with SEM image of the positive electrode composite active material particle. Furthermore, distributions of the sulfide solid electrolyte and the conductive auxiliary agent are shown together. From these views, each area rate of the sulfide solid electrolyte, the conductive auxiliary agent, and the air gap, in a region at a distance of t nm or less from the surface of the positive electrode active material particle, were obtained. As a result, in Example 1, it was shown that the rate of the sulfide solid electrolyte was 84%, and that of the air gap was 16%. Furthermore, in Example 12, it was demonstrated that the rate of the sulfide solid electrolyte was 38%, that of conductive auxiliary agent was 2%, and that of the air gap was 60%.

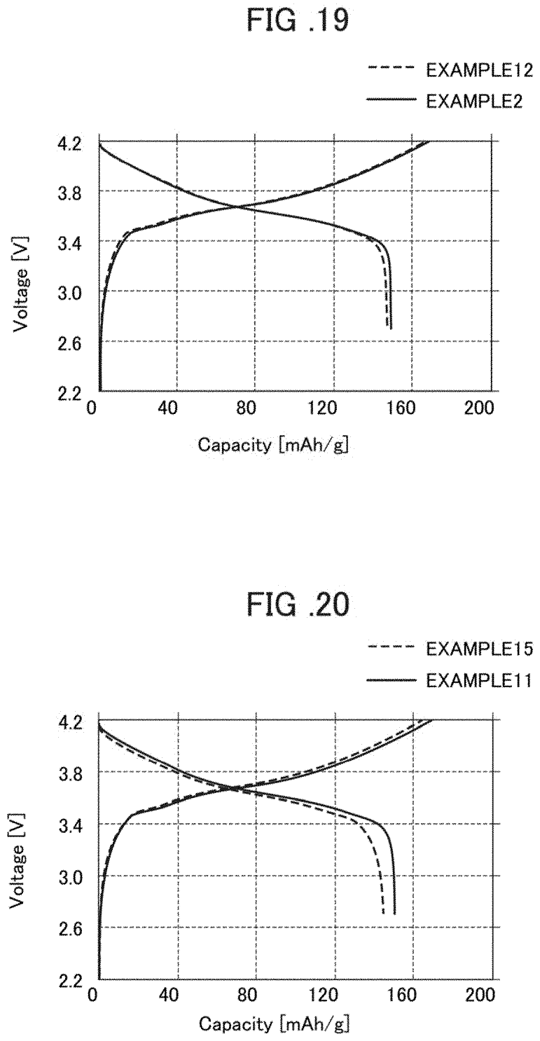

FIG. 19 is a graph showing initial charge/discharge curves at the time when a battery binding force is 60 MPa in Examples 2 and 12. FIG. 20 is a graph showing initial charge/discharge curves at the time when a battery binding force is 10 MPa in Examples 11 and 15. From FIGS. 19 and 20, it is demonstrated that a sufficient charge/discharge capacity can be obtained according to the embodiment regardless of the difference in the battery binding force.

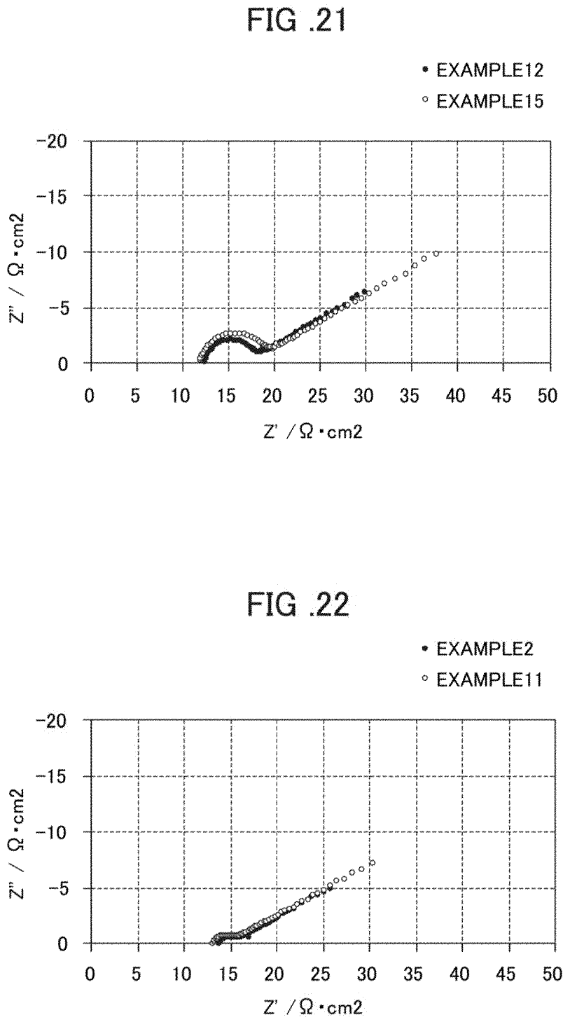

FIG. 21 is a Nyquist diagram of the positive electrode composite active material particles at 50% SOC in Examples 12 and 15. FIG. 22 is a Nyquist diagram of the positive electrode composite active material particles at 50% SOC in Examples 2 and 11. From FIGS. 21 and 22, it is demonstrated that in both Examples, resistance is reduced.

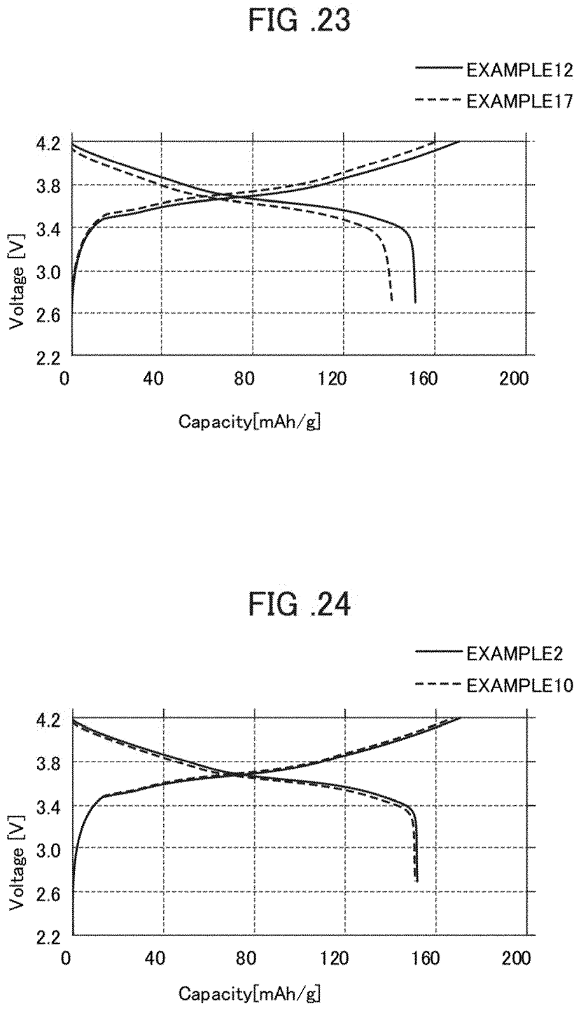

FIG. 23 is a graph showing initial charge/discharge curves of positive electrode composite active material particle in Examples 12 and 17. FIG. 24 is a graph showing initial charge/discharge curves of positive electrode composite active material particle in Examples 2 and 10. From FIGS. 23 and 24, it is demonstrated that in both Examples, sufficient charge/discharge capacity is obtained.

As mentioned above, according to the Examples, it is demonstrated that even when a battery binding force of a solid state is small or even when a blending amount of the positive electrode active material particles is high, the resistance can be reduced.

### EXPLANATION OF REFERENCE NUMERALS

10 Positive electrode composite active material particle
11 Positive electrode active material particle
12 Sulfide solid electrolyte
13 Conductive auxiliary agent
14 Coating material

What is claimed is:

1. A positive electrode composite active material particle comprising a positive electrode active material particle made of a lithium-containing oxide and having a surface at least a part of which is coated with a coating material comprising a sulfide solid electrolyte.

2. The positive electrode composite active material particle according to claim 1, wherein the coating material further comprises a conductive auxiliary agent.

3. The positive electrode composite active material particle according to claim 1, wherein a value of D/t is in a range of 9.0 to 150 where D (nm) is a particle diameter D50 of the positive electrode active material particle and t (nm) is an average thickness of the coating material.

4. The positive electrode composite active material particle according to claim 3, wherein in a cross-sectional image of the positive electrode composite active material particle, a rate of an area of the sulfide solid electrolyte in a region at a distance of t (nm) or less from the surface of the positive electrode active material particle with respect to an entire area of the region is 40% or more.

5. The positive electrode composite active material particle according to claim 1, wherein the positive electrode active material particle comprises a lithium composite oxide.

6. The positive electrode composite active material particle according to claim 1, wherein the positive electrode active material particle is a composite oxide having a layered rock-salt structure comprising any element of Ni, Co, and Mn.

7. A method for producing a positive electrode composite active material particle of claim 1, the method comprising:
a mixing step of dry mixing the positive electrode active material particle and the coating material comprising the sulfide solid electrolyte with each other to obtain the positive electrode composite active material particle having a surface a part of which is coated with the coating material comprising the sulfide solid electrolyte.

8. A positive electrode comprising the positive electrode composite active material particle according to claim 1.

9. A solid-state battery comprising the positive electrode according to claim 8.
